(19) United States
(12) Patent Application Publication
(10) Pub. No.: US 2012/0219192 A1
(43) Pub. Date: Aug. 30, 2012

(54) METHOD OF CONTROLLING A SESSION AT A SELF-SERVICE TERMINAL, AND A SELF-SERVICE TERMINAL

(75) Inventors: Milton Shizuo Noguchi, Jundiai -SP (BR); Wagner Maccari, Jundiai -SP (BR); Edmur Moraes Filho, Jundiai -SP (BR)

(73) Assignee: Itautec S.A. - Grupo Itautec, Bela Vista (BR)

(21) Appl. No.: 13/404,887

(22) Filed: Feb. 24, 2012

(30) Foreign Application Priority Data
Feb. 25, 2011 (BR) PI1101761-9

(51) Int. Cl. G06K 9/00

(52) U.S. Cl. 382/118

(57) ABSTRACT

A method for controlling a session of a self-service terminal utilizes an image capture device that captures image frames for identification of a user's face. If a face is identified, a model is temporarily associated with that face. The face is monitored until the user closes the session, thereby generating possible events. When the user leaves the terminal during the session, or a new face assumes the position formerly held by the previous face, the result of the comparison results in the closing of the session. In the case that the same user remains in place until the end of the session, the result of the comparison allows the reduction of requests for confirmation of user identification data.

### BACKGROUND OF THE INVENTION

1. Technical Field

The present invention is related to the control of sessions at self-service terminals. More particularly, the present invention is related to a control of the processing/closing of sessions at self-service terminals based on the face of the users.

2. Description of the Prior Art

Biometrics is a technique used in a wide range of distinct systems. The technique is based on the capture of information relative to an individual that might be able to differentiate such individual from others. Such information is generally obtained from the individual's fingerprints, voice or facial features. Irrespective of the source, however, the use of biometrics is always associated to the recognition of an individual, either in the context of identifying a person from among a known group, or to check whether the identity being alleged by an individual is actually certifiable. Documents Nos. U.S. Pat. Nos. 6,853,739 and 6,724,919, for example, describe user verification systems based on biometric data.

Both tasks, of verification and identification, are based on the same premise: i) a representative model of each user must be previously generated during a registration phase; and ii) when the system is in use, the biometric data having been obtained is compared with the stored models, thereby generating a probabilistic value that is used to clear the access of that user or to identify the same from among the models having been generated.

Self-service terminals, particularly automatic teller machines used in banking transactions, due to constituting constant targets for fraud, represent a field of application for biometric systems. For those terminals, the option of use of facial features as a data source constitutes a natural choice, since it is the only one that is constantly providing data without unduly bothering the user. In all such terminals, however, the use of facial feature information is associated to the verification of the user, that is, the authorization for use of the terminal if the biometric data having been obtained, upon being compared with the model related to the alleged identity, provides results that confirm that the user is indeed the individual that he or she alleges to be. The document “Face Recognition/Detection by Probabilistic Decision-Based Neural Network” of Lin, Lin and Kung, published in 1997 in IEEE Transactions on Neural Networks, for example, describes how a whole face-based automatic recognition system can be implemented with the use of probabilistic neural networks.

In this context, there is not known to exist, in the prior art, any application that makes use of biometric data for controlling a session initiated at a self-service terminal.

### OBJECTIVES OF THE INVENTION

One of the objectives of the present invention is to provide a method and a self-service terminal that are capable of automatically terminating a session initiated by a user, based on the monitoring of the user's face.

One other objective of the present invention is the provision of a method and a self-service terminal that requires, in a less repetitive manner during the same session, the confirmation of user identification data, also based on the monitoring of the face of the user that initiated the session.

One other objective of the present invention is to provide a method and a self-service terminal capable of sending alerts to a control center and/or to the user that initiated a session at the self-service terminal in the case that more than one face is identified within the field of sight of the camera.

Those objectives and other advantages of the present invention will be further evident from the description to follow and from the drawings attached hereto.

### BRIEF DESCRIPTION OF THE INVENTION

The self-service terminal session control method according to the present invention starts from the beginning of a session initiated by a user. After that point, an image capture device is activated, and starts capturing image frames. Such frames are processed in order to identify at least one face. If a face is identified, a model is temporarily associated to that face. The said face is monitored until the session is terminated by the user, generating the possible events: i) in the case that the user leaves the terminal while the session is in course, or in the case that a new face assumes the position of the previous face, the result of the comparison with the temporary model shall bring about the terminating of the session; and ii) if the same user stays until concluding the session, the result of the comparison with the temporary model will allow the reduction or elimination of user data confirmation requests. The method may further comprise an alert generation step, for the case where more than one face is detected in one or more frames. Such alert may be displayed to the user himself/herself (indicating the presence of an intruder in the region of the terminal) or may be sent to an external control center.

The self-service terminal according to the present invention will comprise a processor capable of executing all the steps of the method described above, a memory means for storing the temporary models, and an image capture device.

### DESCRIPTION OF THE FIGURES

The detailed description provided below refers to the attached figures, wherein:

FIG. 1 there is illustrated an exemplary conventional bank self-service terminal or automatic teller machine;

FIG. 2 there is depicted a flow diagram of the generation of events for control of the session in a self-service terminal in accordance with a preferred embodiment of the present invention; and

FIG. 3 there is shown a block diagram representing the self-service terminal of the present invention.

### DETAILED DESCRIPTION OF THE INVENTION

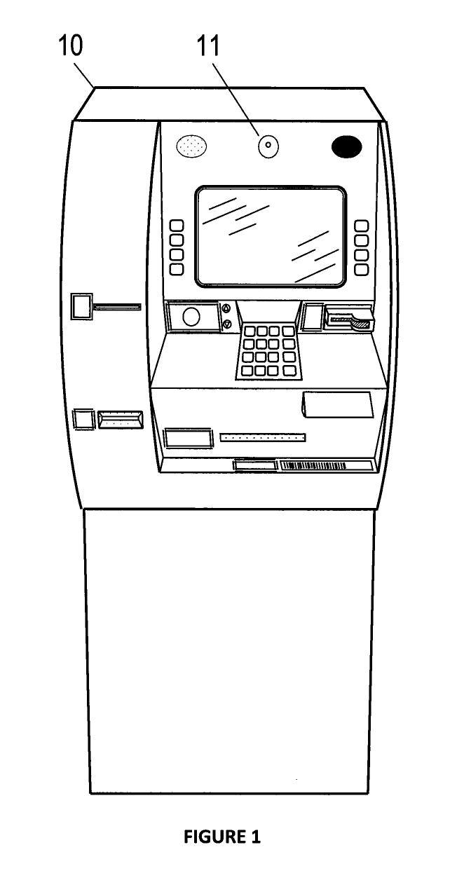

In FIG. 1 there is shown a self-service terminal 10 commonly known in the art. In addition to all the elements required to provide the terminal with functionalities, such as a card reader, a keypad, a deposit collection slot, etc., the self-service terminal 10 should comprise an image capture device 11 duly positioned to capture images of the area located in front of the terminal 10 and of the face of its users.

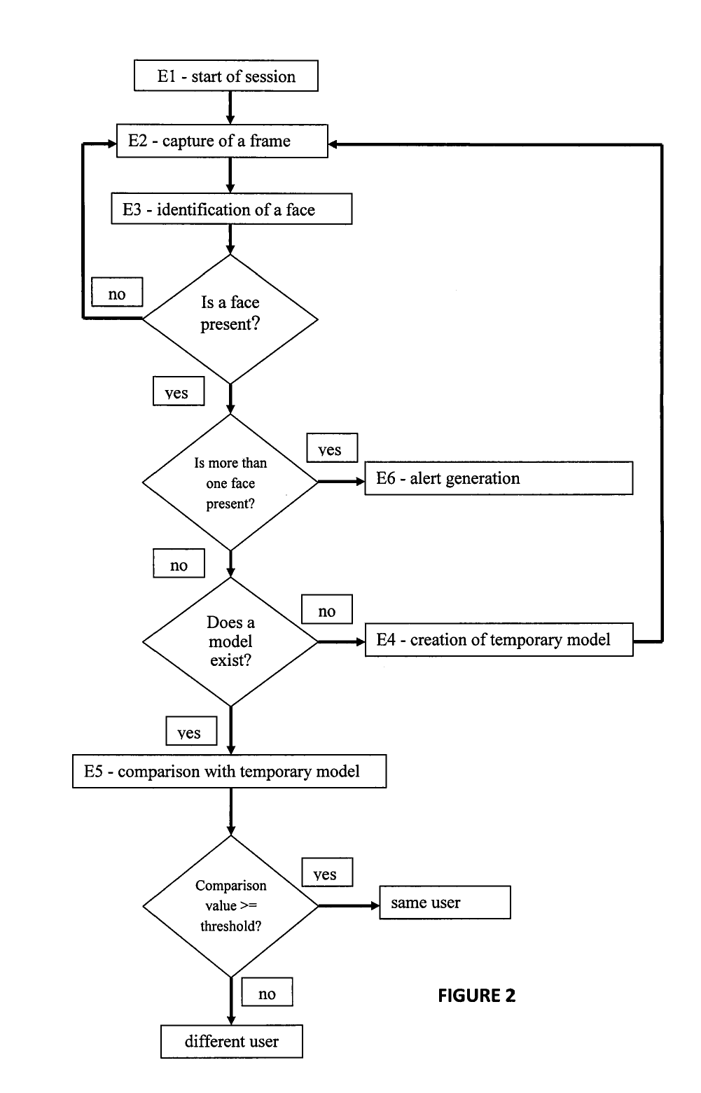

FIG. 2 illustrates the steps of the present invention. A user, upon initiating E1 a session at the terminal 10, normally by inputting a password and/or inserting a card, will enable the operation of the image capture device which will start to capture E2 several frames of its field of sight. Thereupon, the captured frames are processed in the terminal 10 in order to allow the identification of at least one face E3. Optionally, if more than one face is identified in the same image frame, an alert is generated E6 and such alert is displayed to the very user at the terminal or is sent to an external control center. Such identification may indicate the presence of an unauthorized person attempting to visualize some information of the user that initiated the session. The system described in U.S. Pat. No. 5,995,847 shows the manner in which remote alerts can be sent to a remote control center, from events occurring locally at self-service terminals. The description of that document is incorporated herein as a reference.

Alternatively, the image capture device 11 may capture frames irrespective of the beginning of a session. In such case, the processing of the captured frames would be started with the start of the session. Optionally, each captured frame in which a face has been identified may be reduced by the removal of regions located outside of the face of interest.

Subsequently, a given frame containing a face is processed for the extraction of that face and the creation of a temporary model E4, if no model has already been created in the same session. Optionally, such model is a simple histogram and there is attributed thereto an identification number. In the course of the session at the self-service terminal, new frames continue to be captured and processed for the extraction of faces, which are compared with the temporary model having been created E5. The comparison of an extracted face with the model provides similarity values that may be set against a previously established threshold value. If the result of the comparison exceeds the threshold, the face is considered to be the same. If the result of the comparison falls below the threshold, the face is deemed to belong to a different user than that of the model. The capture of new frames for the extraction of faces to be compared with the model, or alternatively, the identification of faces in a captured frame, may be performed, for example, on a frame-by-frame basis, at every ten frames or at other rates depending on the intended application.

By means of the procedure outlined above, whenever that during a session initiated by a user, there is detected a change of face, that is, a change of user, the session may be automatically terminated. Furthermore, the course of a session can be streamlined since that, in case no face change is identified, the obtainment of identification data, for example by means of the information of passwords or the insertion of personal cards, can be dispensed with at each step within the same session. Preferably, for enhanced robustness, the change of faces is established only upon the identification of a number of comparisons that result in values below the threshold. In the same manner, the determination of the presence of two or more faces in the terminal area is established only upon the identification of those faces in a certain number of image frames. It should be understood that the two events described above, e.g., the closing of the session and the streamlining of the course of the session, may be present either individually or simultaneously in the method and the self-service terminal according to the present invention.

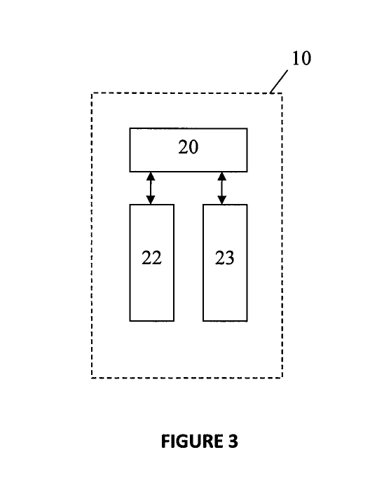

The self-service terminal according to the present invention is essentially based on the elements that already constitute the self-service terminals of the prior art. As may be seen in FIG. 3, the self-service terminal 10 comprises a processor unit 20 connected to a memory device 22 wherein is stored a program comprising instructions that reflect the steps mentioned above. One other memory device 23 is also connected to the processor unit 20 for storing the temporary models. The temporary models may be kept stored for only one session. Alternatively, the models may be stored for a few days, if it is desired to monitor the use of the terminals, such as in the case of frauds, for example. In that case it will be necessary to attribute a unique identification value to each model. In U.S. Pat. No. 6,520,410 it is described how the internal software of a self-service terminal might be developed/modified for the insertion of new functionalities. The content of that document is also incorporated hereby for purposes of reference.

### Signal Processing: Capture of the Image Signal and Search for a Face

The obtainment of image signals by a camera and the search for a face in those signals is already commonly knowledge in the art. Among the various applicable technologies, one may cite that which is described in document No. WO 2008/018887, the contents of which are hereby incorporated for purposes of reference. The system described in that document is capable of performing the identification and tracking, in real time, of more than one face in an image signal stream, by sub-sampling of the digital signal acquired by the camera and by calculating the integral image for a portion of at least one candidate region.

One other adequate and readily applicable technology is the open library OpenCV (http://sourceforge.net/projects/opencvlibrary) (http://opencv.willowgarage.com), initially developed by Intel Corporation and containing functions in computer language for the processing of images in real time. Its content may also be understood by means of the publication “OpenCV: Computer Vision with the OpenCV Library”, which content is also incorporated herein for purposes of reference. Additional programs, based on that same library, were developed for face detection and tracking, such as, for example, the program developed by Zeeshan Ejaz Bhati (www.codeproject.com/KB/library/eyes.aspx).

### Acquisition of a Face, Generation of a Model and Result of the Comparison

The same document No. WO 2008/018887 shows how a face can be identified and its region extracted from a captured frame.

The OpenCV library allows the creation of a histogram, accessible as a normal matrix, from any image supplied thereto. In the present case, such image will be the extracted face. One other functionality of the OpenCV library is the direct comparison of images. In such situation, the face extracted after the beginning of the session will serve as a model, e.g., as a reference face. The faces obtained from the subsequent frames will be the template images that will be compared with the reference image. Various forms of comparison are possible, among which there may be cited the following: the simple squared difference between the images (0 indicating a perfect identity and higher values indicating greater differences); the correlation that multiplies the template by the reference image (high values corresponding to good similarity and low values corresponding to large differences); and the use of correlation coefficients comparing the reference image average to the template average (1 indicating perfect correlation, 0 indicating no correlation, and −1 indicating de-correlation). The values obtained by those comparisons are set against a previously established threshold for the acceptance or rejection of a face as being identical to that of the reference model.

Notwithstanding that the above described techniques are used in a particular embodiment of the present invention, other techniques, including more complex ones such as the probabilistic neural networks, may be used for the creation of the temporary models.

1. A method of controlling a session in a self-service terminal, comprising the steps of:
capture of a plurality of image frames; and
identification of at least one face in the plurality of image frames, characterized by additionally comprising the steps of:
creation of a temporary model from an image frame containing an identified face;
comparison of one or more subsequent image frames, containing an identified face, with the temporary model having been created; and
execution of one or more events based on the result of the comparison.

2. A method, as claimed in claim 1, characterized in that the one or more events are: the closing of the session of the self-service terminal in the case that the result of the comparison indicates that the face having been identified in the one or more subsequent image frame(s) does not belong to the temporary model; and/or the inhibition of user identification data confirmation requests if the result of the comparison indicates that the face having been identified in the one or more subsequent image frames belongs to the temporary model.

3. A method, as claimed in claim 1, characterized in that the creation of the temporary model is carried out from an image frame that was reduced by means of the removal of regions located outside of the area of the face having been identified.

4. A method, as claimed in any one of claim 1, characterized in that the comparison is made based on an image frame that was reduced by means of the removal of regions located outside the area of the face having been identified.

5. A method, as claimed in claim 1, characterized in that the capture of image frames or the identification of faces is performed on a frame-by-frame basis.

6. A method, as claimed in claim 1, characterized in that the result of the comparison is set against a previously established threshold value, the face being deemed to belong to the temporary model if the result of the comparison is higher than or equal to the threshold value, and being deemed to not belong to the temporary model if the result of the comparison is lower than the threshold value.

7. A method, as claimed in 1, characterized in that it additionally comprises the step of displaying an alert at the terminal if more than one face is identified in one or more image frame(s).

8. A method, as claimed in claim 1, characterized in that it additionally comprises the step of sending an alert to a remote control center if more than one face is identified in one or more image frame(s).

9. A method, as claimed in claim 1, characterized in that it additionally comprises the step of excluding the temporary model having been created, by terminating the session.

10. A method, as claimed in claim 1, characterized in that it additionally comprises the steps of exclusion of the temporary model having been created, after a certain period of time, and attribution of a unique identification value to each model having been created.

11. A self-service terminal, comprising:
an image capture device;
a processor unit; and
a memory device,
characterized in that:
the processor unit is adapted to execute the method as defined in claim 1; and
the memory device stores the temporary models having been created.
